(19) United States
(12) Patent Application Publication
(10) Pub. No.: US 2003/0004947 A1
(43) Pub. Date: Jan. 2, 2003

(54) Method, system, and program for managing files in a file system

(75) Inventor: Harriet G. Coverston, New Brighton, MN (US)

Correspondence Address: David W. Victor, KONRAD RAYNES & VICTOR LLP, 315 S. Beverly Drive; Suite 210, Beverly Hills, CA, 90212, US

(73) Assignee: Sun Microsystems, Inc.

(21) Appl. No.: 09/894,478

(22) Filed: Jun. 28, 2001

(51) Int. Cl. G06F 7/00

(52) U.S. Cl. 707/9

(57) ABSTRACT

Provided is a method, system, and program for managing files in a file system. Data is received for a file. The data for the file is stored in a plurality of segments. An index associated with the file indicating how the file data maps to the segments. An Input/Output request is received with respect to an address in the file. The index for the file is used to determine the segment having the requested address in the file. The determined segment including data at the requested address is then accessed.

### BACKGROUND OF THE INVENTION

1. Field of the Invention

The present invention relates to a method, system, and program for managing files in a file system.

2. Description of the Related Art

Many systems utilize large files located in primary storage, such as hard disk drives, that can be up to hundreds of megabytes, gigabytes, and even terabytes in size. Such very large files are often archived on some other storage, such as tape, optical storage, slower disk drives, etc. To edit or access such large files, the user stages the large file into a disk cache. The process to stage a large file into a disk cache from tape or some other slower, backup storage medium, such as optical storage, can take a considerable amount of time. Tape staging operations adversely affect performance because of the time required to stage a large file from tape to the disk cache. Moreover, the entire file must be staged from tape onto the disk cache even if the user only needs to access or update a small portion of the file.

Further, the user cannot restore a file from the backup storage that is larger than the disk cache because such a large file could not be staged into disk cache where it would be available to be accessed and modified after the file is archived onto tape. Thus, the disk cache size provides a constraint on the size of files used in the system. Although, such very large files could be accessed directly on tape, such tape direct access operations would substantially degrade performance.

The above limitations of systems utilizing very large files has become more apparent recently with the advent of multimedia files, such as videos, scientific data, and very large scale databases. Such files are likely archived to tape. Moreover the file system may have to maintain a copy of such files on tape to leave sufficient free space in the disk cache for other files and programs. In fact, in hierarchical storage management (HSM) systems, files are often migrated to tape storage when the data stored in disk cache reaches a certain threshold. HSM systems migrate files to tape to make room for further files being used in the system. Very large files are often likely candidates for migration to tape because their migration will free up more space than other files. Thus, in HSM and other storage systems, users of very large files are likely to have to stage a file from tape into the disk cache whenever they want to access or update data in the very large file. Still further, very large files that are frequently accessed remain in the disk cache, thereby reducing the available disk cache space for other application data.

For the above reasons, there is a need in the art for an improved methodology for managing files in a file system.

### SUMMARY OF THE PREFERRED EMBODIMENTS

Provided is a method, system, and program for managing files in a file system. Data is received for a file. The data for the file is stored in a plurality of segments. An index associated with the file indicates how the file data maps to the segments. An Input/Output request is received with respect to an address in the file. The index for the file is used to determine the segment having the requested address in the file. The determined segment including data at the requested address is then accessed.

In further implementations, the segments are stored in a primary storage. At least one of the segments in the primary storage is copied onto a secondary storage. At least one of the segments copied to the secondary storage is released, wherein space used by the released segment in the primary storage is available for use.

In further implementations, as a result of releasing one or more segments, different segments for one file are capable of being stored in the primary storage and the secondary storage.

Still further, the file data in all the segments is capable of being larger than a storage capacity of the primary storage.

Further provided is method, system, and program for managing files in a primary and secondary storage, wherein the secondary storage is comprised of a plurality of drives and storage devices capable of being mounted in the drives. Data for a file is received and stored in a plurality of segments. An index is associated with the file that indicates how file data maps to the segments. Each segment is written to one of the drives, wherein segments are written to multiple of the drives to distribute the segments across multiple storage devices.

In additional implementations, multiple segments are written in parallel to multiple storage devices in multiple drives. Further segments on multiple storage devices are read from multiple drives to stage multiple segments in parallel into the primary storage.

### BRIEF DESCRIPTION OF THE DRAWINGS

Referring now to the drawings in which like reference numbers represent corresponding parts throughout:

FIG. 1 is an illustration of a computing environment in which aspects of the invention are implemented;

FIG. 2 illustrates a data structure for metadata in accordance with implementations of the invention;

FIG. 3 illustrates a relationship of a file and segments in accordance with implementations of the invention;

FIGS. 4 and 5 illustrate logic to store file data in segments in accordance with implementations of the invention;

FIGS. 6a and 6b illustrate logic to manage I/O requests to files in the file system in accordance with implementations of the invention; and

FIG. 7 illustrates an additional computing environment in which aspects of the invention are implemented.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

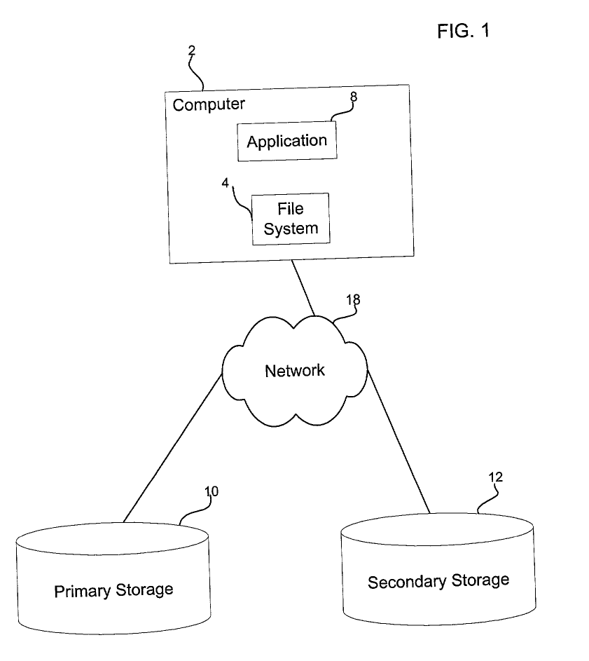

FIG. 1 illustrates a computing environment implementation of the invention. A computer 2, which may comprise any computing device known in the art, including a desktop computer, mainframe, workstation, personal computer, hand held computer, palm computer, laptop computer, telephony device, network appliance, etc., includes a file system 4 and one or more application programs 8. The file system 4 may comprise any file system that an operating system provides to organize and manage files known in the art, such as the file system used with the Sun Microsystems Solaris operating system, Unix file system or any other file system known in the art.** The application program 8 may comprise any application known in the art that creates and accesses data files in the file system 4, such as a database program, word processing program, software development tool or any other application program known in the art. A network 18, which may comprise any network system known in the art, such as Fibre Channel, Local Area Network (LAN), an Intranet, Wide Area Network (WAN), Storage Area Network (SAN), etc., enables communication between the computer 2, primary storage 10, and secondary storage 12. Alternatively, the computer 2 may be connected to the disk cache 10 and tape library 12 via direct transmission lines or cables (not shown). Data transferred between the disk cache 10 and tape library 12 may be transferred through the file system 4 in the computer 2 or, alternatively, directly between the disk cache 10 and the tape library 12 via the network 18 or a direct transmission line (not shown). SOLARIS is a trademark of Sun Microsystems, Inc.; UNIX is a registered trademark of The Open Group; SAM-FS is a trademark of LSC, Inc.

In the described implementations, the file system 4 further includes programs for managing the storage of files in the file system 4 in a primary storage 10 and secondary storage 12. In certain implementations, the primary storage 10 comprises a disk cache or group of interconnected hard disk drives that implement a single storage space. The applications 8 process data stored in the primary storage 10. The secondary storage 12 is used for maintaining one or more backup copies of files in the file system 4 and for expanding the overall available storage space. In certain implementations, the secondary storage 12 comprises a slower access and less expensive storage system than the primary storage 12. For instance, the secondary storage 12 may comprise a tape library including one or more tape drives and numerous tape cartridges, an optical library, slower and less expensive hard disk drives, etc. In certain implementations, once a tape cartridge is mounted in a tape drive, data may be transferred between the primary 10 and secondary 12 storage.

In certain implementations, the file system 4 is capable of performing Hierarchical Storage Management (HSM) related functions, such as automatically archiving files in the primary storage 10 in the secondary storage 12. Files are archived when they meet a set of archive criteria, such as age, file size, time last accessed, etc. The file system 4 may also perform staging operations to copy data archived on the secondary storage 12 to the primary storage 10 to make available to the applications 8. The file system 4 may also perform release operations to free space in the primary storage 10 used by files archived to the secondary storage 12 in order to make more space available for more recent data. In certain implementations, the release operation may utilize high and low thresholds. When the used space in the primary storage 10 reaches a high threshold, the file system 4 releases files in the primary storage 10 that have been archived to secondary storage. The primary storage 10 space used by the released file is available for use to store other data. In certain implementations, the file system 4 stops releasing files when the used storage space is at the low threshold level. Further details of the HSM capabilities that may be included in the file system 4 are described in the LSC, Inc. publication entitled “SAM-FS System Administrator's Guide”, LSC, Inc. publication no. SG-0001, Revision 3.5.0 (1995, July, 2000) and the archiving file system described in U.S. Pat. No. 5,764,972, which publication and patent are incorporated herein by reference in its entirety.

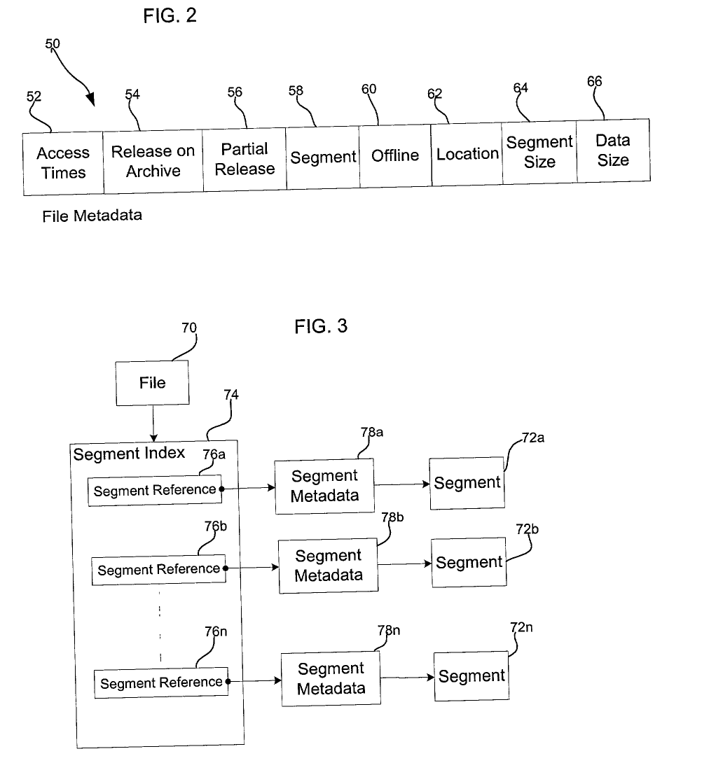

In the described implementations, the file system 4 maintains metadata for each file represented in the file system 4. For instance, in Unix type operating systems, a data structure referred to as the i-node maintains the file metadata. Other operating systems may maintain metadata in different formats. FIG. 2 illustrates information fields maintained in file metadata 50, which is maintained for each file and directory in the file system 4. Below are some of the information fields that may be maintained in the file metadata 50 for files and directories in the file system 4:

Access Times 52: the time the file was last accessed, modified, created, etc.

Release on Archive 54: indicates that once one or more archive copies of the file are made in the secondary storage 12, the file may be subject to an immediate or delayed release operation.

Partial Release 56: indicates that the first n bytes of the file are maintained in the primary storage 10 after the release operation, where n may be a user settable parameter.

Segment 58: indicates that the file data is stored in separate segments as described herein.

Offline 60: indicates that the file is currently resident in the secondary storage 12 and not in the primary storage 10.

Location 62: indicates the location of the file, which may comprise an address in the primary storage and secondary storage, such as the disk or tape volume and block address therein.

Segment Size 64: indicates the size of each segment containing the data for a file.

Data size 66: indicates the amount of data in the segment, which may be less than the segment size. Data may be stored sequentially or the data may be stored non-consecutively in a sparse manner.

Further types of file metadata that may be included with the file metadata 50 are described in U.S. Pat. No. 5,764,972, which was incorporated by reference above.

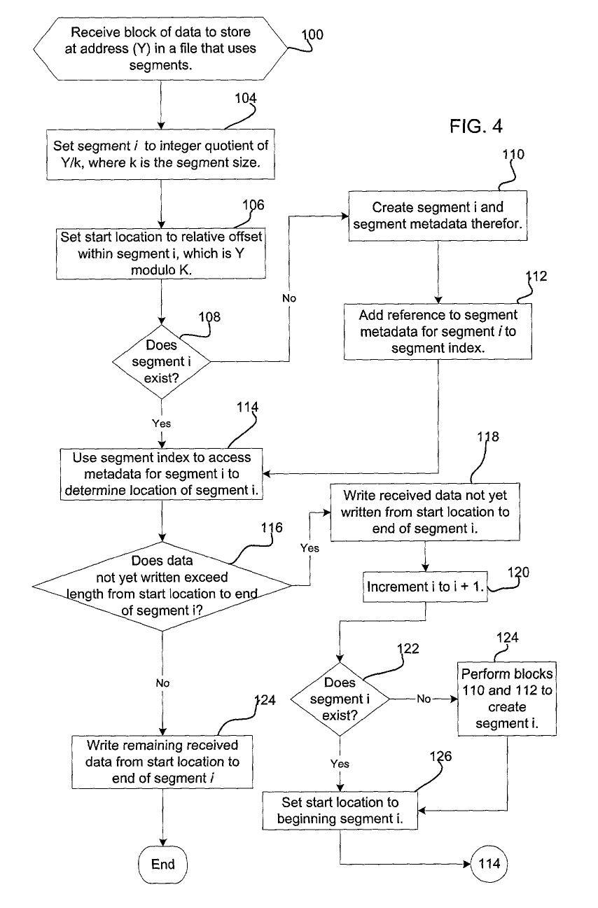

To provide for greater flexibility in managing very large files, such as files that may be hundreds of megabytes, gigabytes or terabytes, the described implementations provide an architecture to allow a single very large file to be stored in separate segments, where the file is distributed across the segments. FIG. 3 illustrates how data from a file 70 is distributed across multiple segments 72a, b . . . n, where each segment 72a, b . . . n is of a same fixed length which may be user specified. Alternatively, the segments may have different byte lengths and/or each segment may include less data than the segment length.

To store the file 70 across multiple segments 72a, b . . . n, the file 70 would be associated with a segment index 74, shown in FIG. 3, that includes a list of references 76a, b . . . n, i.e., pointers, to segment metadata 78a, b . . . n. The references 76a, b . . . n are ordered in the list from first segment 72a to last 72n, thereby providing an order in which the file data maps to particular segments 72a, b . . . n associated with the file 70. The segment metadata 78a, b . . . n would include the same fields maintained for the file metadata 50 (FIG. 2). In certain implementations, the segment index 74 may be stored in the file 70 or stored in the file metadata 50 for the file, or stored in some alternative location and referenced through the file or file metadata 50. In certain implementations, all the file 70 user data is stored in segments 72a, b . . . n and the actual file 70 does not include any user data.

As discussed, in certain implementations, the data for the file 70 is distributed across segments 72a, b . . . n of equal length. In such implementations, the segment number including a specified byte offset into the file 70 can be determined by dividing the specified byte offset by the fixed byte length of each segment. The integer quotient resulting from this division operation comprises the segment number including the data at the specified byte offset into the file 70. The segment 72a, b . . . n including the specified data is the segment whose segment reference 76a, b . . . n is the jth segment reference in the segment order provided by the segment index 74, where j is the determined segment number or resulting integer quotient. The relative byte offset into the determined segment j including the specified byte offset into the file 70 equals the specified byte offset minus the result of multiplying the segment number (i) times the segment length (k) 64. The specified byte offset into the file can then be located in the primary 10 or secondary 12 storage by accessing the physical location indicated in the location field 62, which provides the physical location of the start of the segment j, and then seeking the relative byte offset from the physical location of the start of the segment.

In certain implementations, the segments 72a, b . . . n are not treated as files in the system because they do not have a file name and cannot exceed the fixed segment length 64. Instead, the segments 72a, b . . . n comprise data stored in the primary 10 or secondary 12 storage, where segment metadata maintains the information needed to access the segments on primary 10 or secondary 12 storage.

The file system 4 represents the file as a single file 70 to the user, with the segments 72a, b . . . n remaining transparent to the user. However, the user may issue commands to view the metadata 50 (FIG. 2) for the segments 72a, b . . . n.

Because the metadata 76a, b . . . n is maintained for the segments 72a, b . . . n, standard file system 4 I/O commands may be used to access the segment data. Thus, although the segments 72a, b . . . n do not include many of the attributes of regular files, the file system 4 may access them as any regular file would be accessed using the segment metadata 78a, b . . . n.

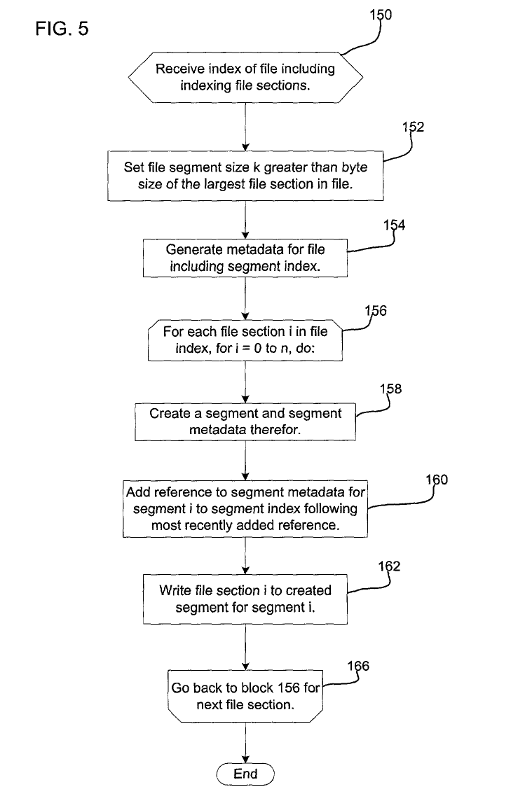

FIG. 4 illustrates logic implemented in the file system 4 to store a block of data to write to an address (Y) within a file 70 comprised of segments 72, a, b . . . n in the case where each segment 72a, b . . . n is of size k. Control begins at block 100 with the file system 4 receiving a block of data to store at address (Y) within one file 70 that is implemented in separate segments 72a, b . . . n. A segment attribute may be associated with an entire file directory, such that any file created in that directory takes the segment attributes, including segment size, defined for the directory and the files therein. Alternatively, the segment attribute may be associated with individual files by setting the segment field 58 to “on” on a file-by-file basis. In certain implementations, when the user sets the segment attribute for a file, the user may also specify the segment length k. Previously, the file system 4 would have generated metadata for the file including a segment index 74 and set the segment field 58 to “on” for the file 70. This metadata would be used to present the file 70 as a single file in the file system 4 to the user. However, actual segments 72a, b . . . n for the file 70 would not have been created and added to the segment index 74 until such additional segments are needed to store data for the file 70.

After receiving the block of data, the file system 4 sets (at block 104) the segment i to the integer quotient of Y divided by k. The start location of the relative offset within segment i of where to begin writing would be set (at block 106) to Y modulo k, or the remainder of Y divided by k.

If (at block 108) segment i does not exist, then the file system 4 creates (at block 110) a segment data structure and segment metadata 78a, b . . . n for the segment i. A reference is added (at block 112) to the metadata for segment i to the segment index 74. From block 112 or block 108 if segment i already exists, then the file system 4 uses the segment index 74 to access the metadata for segment i to determine (at block 114) the location of segment i. If (at block 116) the portion of the block of received data not yet written exceeds the length from the start location within segment i to the end of segment i, then the file system 4 writes (at block 118) to segment i from the start location to the end of segment i received data not yet written. The segment number i is incremented (at block 120) by one. If (at block 122) the next segment i does not exist, then the file system performs (at block 124) steps 110 and 112 to create segment i. From block 124 or block 122 if segment i already exists, then the start location is set (at block 126) to the beginning of segment i, and control proceeds to block 114 to write data to the new segment i.

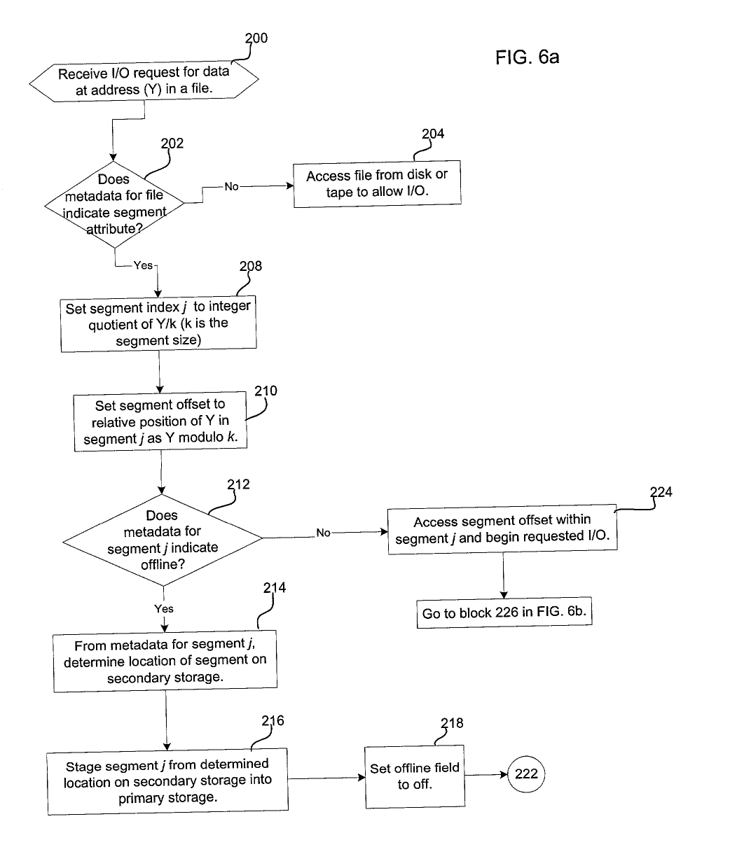

FIG. 5 illustrates logic implemented in a program used in conjunction with the file system 4 to take a very large file already existing that has an index of different sections and store the data for such an indexed file in segments. For instance, a large video file may be comprised of separate video clips, where a file index indicates the offsets in the file of each video clip. Control begins at block 150 upon receiving a file and an index of a file specifying file sections at offsets into the received file 70. In certain implementations, a user may specify (at block 152) the segment size k as greater than the largest file section to allow the file system 4 to store additional data in each segment. Still further, the user may specify the segment size significantly larger than the largest file section size to allow room in the segment to expand the size of one file section, e.g., add material to a video clip. Metadata is then generated (at block 154) for the file along with a segment index 74 (FIG. 3). The segment field 58 would be set to “on”.

For each file section i in the file index, a loop is performed at blocks 156 through 166 to store the file sections into segments 72a, b . . . n. At block 158, the file system 4 creates a segment 72a, b . . . n and segment metadata 78a, b . . . n therefor. The file system 4 further adds a reference to the segment metadata i created for segment i to the segment index 74 following the last added reference, such that the segment references 76a, b . . . n are ordered in the list according to the order in which file data is written to the segments 72a, b . . . n File section i from the very large file is then written (at block 162) to segment i. Control then proceeds (at block 166) back to block 156 to write the next file section to a new segment.

Once the segments 72a, b . . . n are generated, they would be stored in the primary storage 10. The segment metadata 78a, b . . . n provides information that may be used to determine whether the segments 72a, b . . . n should be archived, released, and, if released, whether a partial file is maintained on the primary storage 10. The segment 72a, b . . . n may be archived and released using the same criteria that is applied to any regular file in the file system. Further, the criteria may be applied to both segments 72a, b . . . n and non-segmented files to determine which files to release. Further, segments 72a, b . . . n may be archived and released at different times, thereby only leaving less than all the segments 72a, b . . . n of the file 70 in the primary storage 10. For instance, a more recently accessed segment or file may remain in the primary storage 10 while a segment or file that is one of the least recently used segments and files may be marked for release. In certain implementations, if a segment is not entirely filled with valid data, only valid data from the segment in the primary storage 10 is archived in the secondary storage 12. Further, when staging data for a segment from the secondary 12 to the primary 10 storage, only valid data is staged from the secondary storage 12.

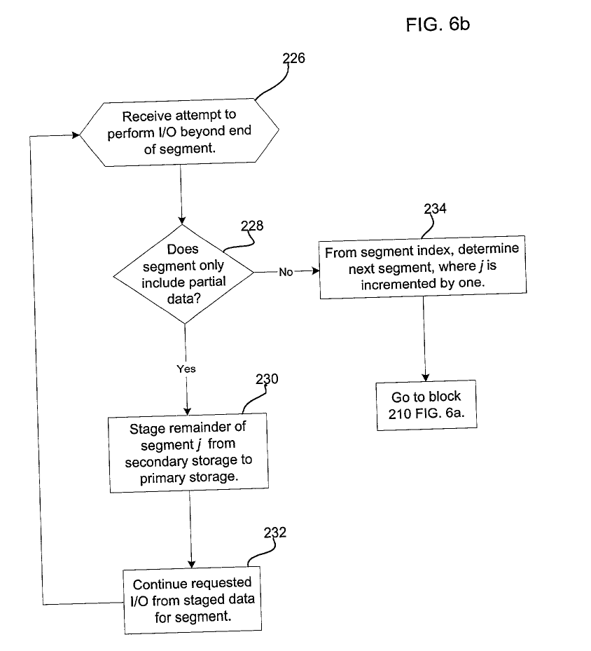

FIGS. 6a, b illustrate logic implemented in the file system 4 to manage an Input/Output (I/O) request, i.e., read or write, to an address (Y) in a file in the file system 4, beginning at block 200. If (at block 202) the file is not marked for segmentation, i.e., the segment field 58 (FIG. 2) is “off”, then the data for the file is stored in a single file and control proceeds to block 204 to handle the I/O request for the file in a manner known in the art. The non-segmented file may be staged from secondary 12 to primary 10 storage if the file is not in the primary storage 10 or if the file is a partial file and the file system 4 attempts to access beyond the end of the partial data, e.g., first n bytes of the file 70, maintained in the partial file. In certain implementations, the file system 4 may make data available to I/O requests as soon as the data is staged into the memory and before the entire segment is staged. Attempts to read beyond the first n bytes in the partial file would trigger an operation to stage further segments 72a, b . . . n from the file into the primary storage 10. If the file 70 is segmented, then the file system 4 sets (at block 208) the segment j including the requested address (Y) to the integer quotient of Y divided by k. The segment offset, which indicates the relative byte offset into segment j including the requested address, is then set (at block 210) to Y modulo k, or the remainder of Y divided by k.

If (at block 212) the segment metadata j for the segment j indicates that the segment j is not on the primary storage 10, i.e., the offline field 60 (FIG. 2) is “on”, then the file system 4 determines (at block 214) the location in secondary storage 12 of the segment j from the location field 62 (FIG. 2) in the segment j metadata. The location may specify a particular tape volume or cartridge, optical disk, slower hard disk drive, etc., and block address on such device. The file system 4 then stages (at block 216) the segment j from the determined location in secondary storage 12 into the primary storage 10 and updates (at block 218) the offline field 60 in the segment metadata j to indicate that the segment j is in the primary storage 10. The file system 4 may further update the location field 62 to indicate the location in the primary storage 10 of the staged in segment j. The location field 62 would indicate the primary 10 and/or secondary 12 storage location where the segment j is resident. If the secondary storage 12 comprises a tape library, then the tape library may have to mount a tape cartridge including the requested segment.

After the segment j is in primary storage 10 from blocks 212 or 218, in whole or as a partial file, the file system 4 then accesses (at block 224) the determined segment offset within segment j, which includes the start of the requested data. Control then proceeds to block 226 in FIG. 6b.

If (at block 226) during the I/O request the file system 4 attempts to access data beyond the end of the segment j then the file system 4 determines (at block 228) whether the segment j comprises a partial file. If so, then the file system 4 stages (at block 230) the remainder of the segment j from secondary storage 12 to the primary storage 10 where the I/O request can continue accessing data. Otherwise, if the segment j is not a partial file, i.e., a full segment, then the file system 4 determines (at block 226) the next segment (i+1) maintaining the next data for the file 70. Control then proceeds back to block 210 to access the next segment.

With the logic of FIGS. 6a, b, the file system 4 only has to maintain in the primary storage 10 the particular segments 72a, b . . . n including the data from the file 70 that is currently active, where each segment 72a, b . . . n is less in size than the file 70. This increases the read and write performance because the data to read or update may be quickly accessed by going right to the segment 72a, b . . . n including the requested data. Further, maintaining segments for a file avoids the need to have to stage in the entire file 70 from secondary storage 12, which may be a slower access device, such as a tape drive, because only the particular segment 72a, b . . . n including the requested data is staged. This further substantially improves read and write performance.

Moreover, with the described implementations, the file 70 size may be greater in size then the primary storage 10 as long as the segment 72a, b . . . n size is less than the primary storage 10. This is possible because only the particular segments 72a, b . . . n being accessed need to remain in the primary storage 10. If the primary storage 10 reaches the high threshold, then the file system 4 may begin releasing files in the primary storage 10 until the low threshold amount of space is available. The files released may include segments 72a, b . . . n of the file 70 being accessed as well as other files based on file release criteria known in the art. This release operation makes room in the primary storage 10 to allow access of further segments 72a, b . . . n. In this way, all the data from a file 70 that as a whole is larger than the primary storage 10 space may be accessed by staging in segments of the data that is currently being accessed and releasing older segments and other non-segments in the primary storage 10.

With the described implementations, the application 8 continues to access the file 70 as a single file using the file system 4 file access commands. However, the file system 4, transparent to the user, provides special handling for files 70 that have the segment attribute to manage such files 70 as separate segments 72a, b . . . n

Further implementations provide a stage ahead feature. If a stage ahead attribute is set, then the file system 4 would begin prefetching or staging ahead multiple segments following a segment accessed from the secondary storage 12, e.g., offline. Further, when accessing data in sequential mode, the file system 4 would want to stage ahead to improve the performance of the sequential access. A stage ahead attribute would indicate a number of segments to stage ahead upon accessing one segment in secondary storage 12 to make further segments available for continued accesses to the file 70 data. The number of segments to stage ahead may be user settable.

Still further, in certain implementations, in releasing segments 72a, b . . . n from the primary storage 10, the file system 4 may only save partial data for the first segment 72a, and all remaining segments 72b . . . n are subject to full release from the primary storage 10. In this way, partial data is only maintained for the first segment 72a.

### Striping Segments Across Tape Drives

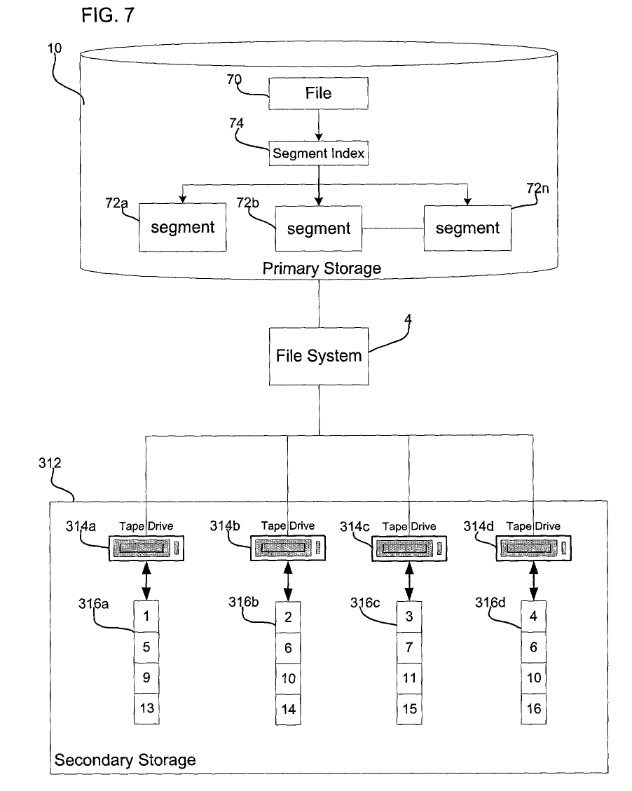

FIG. 7 illustrates an additional implementation where the secondary storage 312 is comprised of a plurality of tape drives 314a, b, c, d, where each tape drive can read and write data to tape cartridges 316a, b, c, d. FIG. 7 illustrates how the file system 8 may alternate writing segments 72a, b . . . n to the four tape cartridges 312a, b, c, d in parallel, such that segments 1, 5, 9, 13 are written to tape cartridge 314a, segments 2, 6, 10, 14 are written to tape cartridge 314b, segments 3, 7, 11, 15 are written to tape cartridge 314c, and segments 4, 8, 12, 16 are written to tape cartridge 314d. The segment index 74 includes references to segment metadata 78a, b . . . n, which in turn references the segments 72a, b . . . n striped across the tape cartridges 314a, b, c, d. In this way, a file 70 is distributed across multiple tape cartridges 314a, b, c, d. The user can set an attribute indicating some number of the available tape cartridges 314a, b, c, to use in the striping operation.

This implementation improves write performance because the file system 4 can write in parallel multiple segments to the different tape drives 312a, b, c, d to increase the write process by a factor of n, where n is the number of tape drives. Moreover, a read used in conjunction with the stage ahead feature improves performance because the file system 4 can in parallel stage multiple segments 72a, b . . . n into the primary storage 10.

### Additional Implementation Details

The technique for managing data in a file system may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments of the configuration discovery tool are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In the illustrations, a certain number of devices were shown. For instance, FIG. 1 illustrates one primary 10 and secondary 12 storage device and FIG. 8 illustrates four tape cartridges and tape drives. However, additional or fewer devices than shown may be used, e.g., more or less tape cartridges and tape drives may be included in the secondary storage 12. Further, the primary 10 and secondary 12 storage may be comprised of multiple storage devices and systems.

The described file management operations were are performed by the file system component of an operating system. In alternative implementations, certain of the operations described as performed by the file system may be performed by some other program executing in the computer 2, such as an application program or middleware.

The described implementations may be used with very large files such as video/movie applications to allow editors to access only specific parts of a video image without having to read the entire file or rearchive the entire video. Moreover, the user may work on multiple video files concurrently by only staging in the particular segments of the video files that are needed. The described implementations may also be used with other types of very large files, such as satellite image data, data collected during an experiment that generates a large amount of data, and backup programs that write very large files to tape. With the described implementations, by writing data generated as part of a large, continuous data streams to segments, completed segments may be archived and released to free up more space in the primary storage for further of the data being continually generated by the application. This allows the file system 4 to handle a continuous stream of data to write to a single file without reaching a point where no further data can be handled because the primary storage has become full.

Although the described implementations concern applying the segmentation technique to very large files, the described segmentation technique may apply to files of any size, and is not limited to very large files.

In the described implementations, the primary storage comprised a faster access storage than the secondary storage, and the storage media were different. Alternatively, the primary storage and secondary storage may have the same access speeds and be implemented on the same storage media.

The program flow logic described in the flowcharts indicated certain events occurring in a certain order. Those skilled in the art will recognize that the ordering of certain programming steps or program flow may be modified without affecting the overall operation performed by the preferred embodiment logic, and such modifications are in accordance with the preferred embodiments.

The described implementations were discussed with respect to a Unix based operating systems. However, the described implementations may apply to any operating system that provides file metadata and allows files in the system to be associated with different groups of users.

In the described implementations, file information, such as the segment index, and other file attributes was maintained in file metadata used by the file system. Alternatively, the file attribute information and segment index may be maintained in data structures and tables other than the file metadata used by the file system.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for managing files in a file system, comprising:
receiving data for a file;
storing the data for the file in a plurality of segments;
generating an index associated with the file indicating how the file data maps to the segments;
receiving an Input/Output request with respect to an address in the file;
using the index for the file to determine the segment including data at the requested address in the file; and
accessing the determined segment including the data at the requested address.

2. The method of claim 1, wherein data is stored in the segments by:
writing the received file data to one segment; and
writing further received data for the file to subsequent segments if the last segment to which the received data was written has no more available space.

3. The method of claim 1, wherein each segment has a fixed byte length, wherein the index provides a segment order indicating an order in which file data is written to the segments, and wherein the index for the file is used to determine the segment including data at the requested address in the file by:
determining an offset into the file including the data at the requested address; and
determining an integer quotient value resulting from the offset into the file divided by the fixed byte length, wherein the segment including the data at the requested address is the segment at the integer quotient value in the segment order.

4. The method of claim 3, further comprising:
receiving user input indicating the fixed byte length of each segment.

5. The method of claim 1, further comprising:
providing a segment size that is at least greater than a byte size of a largest section within the file; and
writing each file section to one segment.

6. The method of claim 1, further comprising:
storing the segments in a primary storage;
copying at least one of the segments in the primary storage onto a secondary storage; and
releasing at least one of the segments copied to the secondary storage, wherein space used by the released segment in the primary storage is available for use.

7. The method of claim 6, wherein as a result of releasing one or more segments, different segments for one file are capable of being stored in the primary storage and the secondary storage.

8. The method of claim 6, wherein accessing the determined segment including the requested address further comprises:
determining whether the determined segment is available in the primary storage; and
copying the determined segment from the secondary storage to the primary storage if the determined segment is not available in the primary storage.

9. The method of claim 6, wherein releasing the segment comprises:
storing a partial version of the released segment including less than all data in the segment, wherein the segment data not in the partial version is stored in the secondary storage, wherein the partial version remains on the primary storage after the segment is released.

10. The method of claim 9, wherein the partial version of the determined segment is on the primary storage and wherein accessing the determined segment including the requested address further comprises:
accessing the partial version of the determined segment on the primary storage to access the data therein;
reaching the end of the partial version when accessing data therein;
staging from the secondary storage to the primary storage data from the determined segment that is not in the partial version; and
accessing the data from the determined segment staged from the secondary storage to the primary storage.

11. The method of claim 9, wherein the partial version is stored only for a first segment of the segments associated with the file.

12. The method of claim 6, further comprising:
accessing data at the end of the segment, wherein the I/O request requires further file data after accessing the end of the segment;
determining from the index a next segment including file data following the file data at the end of the segment data; and
accessing the next segment in the primary storage to access the further required file data.

13. The method of claim 6, further comprising:
maintaining metadata for each segment that is also maintained for files in the file system; and
using the metadata for segments and files to determine when to copy segments and files to the secondary storage and when to release segments and files in the primary storage.

14. The method of claim 13, wherein segments and files in the primary storage are released according to their metadata if used space in the primary storage reaches a threshold level.

15. The method of claim 6, wherein the file data in all the segments for the file is capable of being larger than a storage capacity of the primary storage.

16. The method of claim 6, further comprising:
reading data from one target segment on the secondary storage;
determining whether a stage attribute is specified indicating a number of segments to stage ahead; and
initiating read requests to stage the number of subsequent segments following the target segment from the secondary storage to the primary storage.

17. The method of claim 16, further comprising:
receiving user input indicating the number of segments to stage ahead.

18. The method of claim 1, wherein the segment does not have a file name and is not represented as a file in the file system.

19. The method of claim 1, wherein the index is stored in the file, wherein no user data is stored in the file and all the user data is distributed in the segments.

20. A method for managing files in a primary and secondary storage, wherein the secondary storage is comprised of a plurality of drives and storage devices capable of being mounted on the drives, comprising:
receiving data for a file;
storing the data for the file in a plurality of segments;
generating an index associated with the file indicating how file data maps to segments; and
writing each segment to one of the drives, wherein segments are written to multiple of the drives to distribute the segments across multiple storage devices.

21. The method of claim 20, wherein multiple segments are written in parallel to multiple storage devices in multiple drives.

22. The method of claim 20, further comprising reading segments on multiple storage devices from multiple drives to stage multiple segments in parallel into the primary storage.

23. The method of claim 20, wherein the drives comprise tape drives and wherein the storage devices comprise tape cartridges.

24. A system for managing files, comprising:
a computer readable medium;
a storage system;
means for receiving data for a file;
means for storing the data for the file in a plurality of segments in the storage device;
means for generating an index in the computer readable medium associated with the file indicating how the file data maps to the segments;
means for receiving an Input/Output request with respect to an address in the file;
means for using the index for the file to determine the segment including data at the requested address in the file; and
means for accessing the determined segment including the data at the requested address.

25. The system of claim 24, wherein the means for storing the for the file in the segments performs:
writing the received file data to one segment; and
writing further received data for the file to subsequent segments if the last segment to which the received data was written has no more available space.

26. The system of claim 24, wherein each segment has a fixed byte length, wherein the index provides a segment order indicating an order in which file data is written to the segments, and wherein means for using the index for the file to determine the segment including data at the requested address in the file performs:
determining an offset into the file including the data at the requested address; and
determining an integer quotient value resulting from the offset into the file divided by the fixed byte length, wherein the segment including the data at the requested address is the segment at the integer quotient value in the segment order.

27. The system of claim 26, further comprising:
means for receiving user input indicating the fixed byte length of each segment.

28. The system of claim 24, further comprising:
means for providing a segment size that is at least greater than a byte size of a largest section within the file; and
means for writing each file section to one segment.

29. The system of claim 24, wherein the storage system comprises a primary storage, further comprising:
a secondary storage;
means for copying at least one of the segments in the primary storage onto the secondary storage; and
means for releasing at least one of the segments copied to the secondary storage, wherein space used by the released segment in the primary storage is available for use.

30. The system of claim 29, wherein as a result of releasing one or more segments, different segments for one file are capable of being stored in the primary storage and the secondary storage.

31. The system of claim 29, wherein the means for accessing the determined segment including the requested address further performs:
determining whether the determined segment is available in the primary storage; and
copying the determined segment from the secondary storage to the primary storage if the determined segment is not available in the primary storage.

32. The system of claim 29, wherein the means for releasing the segment performs:
storing a partial version of the released segment including less than all data in the segment, wherein the segment data not in the partial version is stored in the secondary storage, wherein the partial version remains on the primary storage after the segment is released.

33. The system of claim 32, wherein the partial version of the determined segment is on the primary storage and wherein the means for accessing the determined segment including the requested address further performs:
accessing the partial version of the determined segment on the primary storage to access the data therein;
reaching the end of the partial version when accessing data therein;
staging from the secondary storage to the primary storage data from the determined segment that is not in the partial version; and
accessing the data from the determined segment staged from the secondary storage to the primary storage.

34. The system of claim 32, wherein the partial version is stored only for a first segment of the segments associated with the file.

35. The system of claim 29, further comprising:
means for accessing data at the end of the segment, wherein the I/O request requires further file data after accessing the end of the segment;
means for determining from the index a next segment including file data following the file data at the end of the segment data; and
means for accessing the next segment in the primary storage to access the further required file data.

36. The system of claim 29, further comprising:
means for maintaining metadata for each segment that is also maintained for files in the file system; and
means for using the metadata for segments and files to determine when to copy segments and files to the secondary storage and when to release segments and files in the primary storage.

37. The system of claim 24, wherein segments and files in the primary storage are released according to their metadata if used space in the primary storage reaches a threshold level.

38. The system of claim 29, wherein the file data in all the segments for the file is capable of being larger than a storage capacity of the primary storage.

39. The system of claim 29, further comprising:
means for reading data from one target segment on the secondary storage;
means for determining whether a stage attribute is specified indicating a number of segments to stage ahead; and
means for initiating read requests to stage the number of subsequent segments following the target segment from the secondary storage to the primary storage.

40. The system of claim 39, further comprising:
means for receiving user input indicating the number of segments to stage ahead.

41. The system of claim 24, wherein the segment does not have a file name and is not represented as a file in the file system.

42. The system of claim 24, wherein the index is stored in the file, wherein no user data is stored in the file and all the user data is distributed in the segments.

43. A system method for managing files, comprising:
a primary storage;
a secondary storage comprised of a plurality of drives and storage devices capable of being mounted on the drives;
means for receiving data for a file;
means for storing the data for the file in a plurality of segments on the primary storage;
means for generating an index associated with the file indicating how file data maps to segments; and
means for writing each segment to one of the drives, wherein segments are written to multiple of the drives to distribute the segments across multiple storage devices.

44. The system of claim 43, wherein multiple segments are written in parallel to multiple storage devices in multiple drives.

45. The system of claim 43, further comprising
means for reading segments on multiple storage devices from multiple drives to stage multiple segments in parallel into the primary storage.

46. The system of claim 43, wherein the drives comprise tape drives and wherein the storage devices comprise tape cartridges.

47. An article of manufacture for managing files in a file system, comprising:
receiving data for a file;
storing the data for the file in a plurality of segments;
generating an index associated with the file indicating how the file data maps to the segments;
receiving an Input/Output request with respect to an address in the file;
using the index for the file to determine the segment including data at the requested address in the file; and
accessing the determined segment including the data at the requested address.

48. The article of manufacture of claim 47, wherein data is stored in the segments by:
writing the received file data to one segment; and
writing further received data for the file to subsequent segments if the last segment to which the received data was written has no more available space.

49. The article of manufacture of claim 47, wherein each segment has a fixed byte length, wherein the index provides a segment order indicating an order in which file data is written to the segments, and wherein the index for the file is used to determine the segment including data at the requested address in the file by:
determining an offset into the file including the data at the requested address; and
determining an integer quotient value resulting from the offset into the file divided by the fixed byte length, wherein the segment including the data at the requested address is the segment at the integer quotient value in the segment order.

50. The article of manufacture of claim 49, further comprising:
receiving user input indicating the fixed byte length of each segment.

51. The article of manufacture of claim 47, further comprising:
providing a segment size that is at least greater than a byte size of a largest section within the file; and
writing each file section to one segment.

52. The article of manufacture of claim 47, further comprising:
storing the segments in a primary storage;
copying at least one of the segments in the primary storage onto a secondary storage; and
releasing at least one of the segments copied to the secondary storage, wherein space used by the released segment in the primary storage is available for use.

53. The article of manufacture of claim 52, wherein as a result of releasing one or more segments, different segments for one file are capable of being stored in the primary storage and the secondary storage.

54. The article of manufacture of claim 52, wherein accessing the determined segment including the requested address further comprises:
determining whether the determined segment is available in the primary storage; and
copying the determined segment from the secondary storage to the primary storage if the determined segment is not available in the primary storage.

55. The article of manufacture of claim 52, wherein releasing the segment comprises:
storing a partial version of the released segment including less than all data in the segment, wherein the segment data not in the partial version is stored in the secondary storage, wherein the partial version remains on the primary storage after the segment is released.

56. The article of manufacture of claim 55, wherein the partial version of the determined segment is on the primary storage and wherein accessing the determined segment including the requested address further comprises:
accessing the partial version of the determined segment on the primary storage to access the data therein;
reaching the end of the partial version when accessing data therein;
staging from the secondary storage to the primary storage data from the determined segment that is not in the partial version; and
accessing the data from the determined segment staged from the secondary storage to the primary storage.

57. The article of manufacture of claim 55, wherein the partial version is stored only for a first segment of the segments associated with the file.

58. The article of manufacture of claim 52, further comprising:
accessing data at the end of the segment, wherein the I/O request requires further file data after accessing the end of the segment;
determining from the index a next segment including file data following the file data at the end of the segment data; and
accessing the next segment in the primary storage to access the further required file data.

59. The article of manufacture of claim 52, further comprising:
maintaining metadata for each segment that is also maintained for files in the file system; and
using the metadata for segments and files to determine when to copy segments and files to the secondary storage and when to release segments and files in the primary storage.

60. The article of manufacture of claim 59, wherein segments and files in the primary storage are released according to their metadata if used space in the primary storage reaches a threshold level.

61. The article of manufacture of claim 52, wherein the file data in all the segments for the file is capable of being larger than a storage capacity of the primary storage.

62. The article of manufacture of claim 52, further comprising:
reading data from one target segment on the secondary storage;
determining whether a stage attribute is specified indicating a number of segments to stage ahead; and
initiating read requests to stage the number of subsequent segments following the target segment from the secondary storage to the primary storage.

63. The article of manufacture of claim 62, further comprising:
receiving user input indicating the number of segments to stage ahead.

64. The article of manufacture of claim 47, wherein the segment does not have a file name and is not represented as a file in the file system.

65. The article of manufacture of claim 47, wherein the index is stored in the file, wherein no user data is stored in the file and all the user data is distributed in the segments.

66. An article of manufacture for managing files in a primary and secondary storage, wherein the secondary storage is comprised of a plurality of drives and storage devices capable of being mounted on the drives, by:
receiving data for a file;
storing the data for the file in a plurality of segments;
generating an index associated with the file indicating how file data maps to segments; and
writing each segment to one of the drives, wherein segments are written to multiple of the drives to distribute the segments across multiple storage devices.

67. The article of manufacture of claim 66, wherein multiple segments are written in parallel to multiple storage devices in multiple drives.

68. The article of manufacture of claim 66, further comprising reading segments on multiple storage devices from multiple drives to stage multiple segments in parallel into the primary storage.

69. The article of manufacture of claim 66, wherein the drives comprise tape drives and wherein the storage devices comprise tape cartridges.
